(19) United States
(12) Patent Application Publication
(10) Pub. No.: US 2016/0281955 A1
(43) Pub. Date: Sep. 29, 2016

(54) FLAT PANEL LUMINAIRE

(71) Applicant: DAVINCI INDUSTRIAL INC., NEW TAIPEI CITY (TW)

(72) Inventor: HUA-JUNG CHIU, TAOYUAN COUNTY (TW)

(21) Appl. No.: 14/666,365

(22) Filed: Mar. 24, 2015

(51) Int. Cl. F21V 5/00; F21S 6/00; F21S 8/06; F21S 4/28

(52) U.S. Cl. CPC F21V 5/00; F21S 4/28; F21S 6/002; F21S 6/005; F21S 8/06; F21Y 2103/003

(57) ABSTRACT

Disclosed is a flat panel luminaire, comprising: a frame assembly; a first light transmitting plate, disposed at one side of the frame assembly; a second light transmitting plate, disposed at the other side of the frame assembly in parallel to and opposite to the first light transmitting plate; and at least one light emitting device, disposed inside the frame assembly and located between the first light transmitting plate and the second light transmitting plate, wherein the first light transmitting plate and the second light transmitting plate have different light transmittances, so that an amount of light generated by the light emitting device and transmitted from the direction of the first light transmitting plate is different from an amount of light generated by the light emitting device and transmitted from the direction of the second light transmitting plate.

### BACKGROUND OF THE INVENTION

1. Field of the Invention

The present invention relates to a flat panel luminaire, and in particular, to a flat panel luminaire for indoor illumination.

2. Description of Related Art

Common illumination luminaries currently in the market generally have a lampshade and a light emitting device (such as an incandescent bulb, a fluorescent tube, or a light emitting diode) disposed in the lampshade. The light emitting device is disposed at a side of the lampshade and light generated by the light emitting device is reflected by the lampshade and projected into a certain region.

The main function of a lampshade used in a conventional illumination luminaire (for example, an indoor illumination lamp or a street lamp) is to enable light from the light emitting device to be projected at a certain angle to intensively irradiate a certain illumination region and to be diffused evenly, so that the illumination luminaire provides uniform illuminance in the light projection region. Therefore, the lampshade of the conventional illumination luminaire generally includes a reflection plate for reflecting light and a diffusion plate or a light transmitting cover for diffusing light.

The lampshade of the conventional illumination luminaire is generally designed so that light generated by the illumination luminaire can only irradiate in a single direction. However, because the conventional illumination luminaire only has a single light outgoing direction, the light of the luminaire is intensively projected into the projection region and cannot irradiate in the range outside the light projection region, so that the light illumination intensity is uneven inside the light projection region and outside the light projection region, resulting in too strong a contrast. As a result, visual discomfort is caused and vision may be easily damaged. Therefore, in the past, when indoor illumination is arranged, in addition to a primary illumination luminaire, other auxiliary light sources must be arranged for illuminating the space outside an illumination region of the indoor primary luminaire to balance the light illumination intensity inside and outside a light irradiation region of the primary illumination luminaire, avoiding the visual discomfort problem caused by too strong contrast.

Thus, it has become an important issue in the art to be solved, through improvement in structural design, the problem that the conventional illumination luminaire only has a light projection region in a single direction, resulting in uneven indoor illumination intensity and thus too strong contrast.

### SUMMARY OF THE INVENTION

The main objective of the present invention is to provide a flat panel luminaire having two different light outgoing directions, for solving the problem that a conventional illumination luminaire only has a single light projection region, resulting in uneven light illumination intensity and thus too strong contrast inside and outside a light irradiation region.

A flat panel luminaire according to an embodiment of the present invention comprises: a frame assembly; a first light transmitting plate, disposed at one side of the frame assembly; a second light transmitting plate, disposed at the other side of the frame assembly in parallel to and opposite to the first light transmitting plate; and at least one light emitting device, disposed inside the frame assembly and located between the first light transmitting plate and the second light transmitting plate, wherein the frame assembly is formed of two side frames, two connection plates, and a central support, the two side frames and the two connection plates together enclosing an accommodating space; the first light transmitting plate and the second light transmitting plate are disposed at both sides of the accommodating space, respectively, and have different light transmittances so that an illumination intensity of light generated by the light emitting device and transmitted from the first light transmitting plate is different from an illumination intensity of light generated by the light emitting device and transmitted from the second light transmitting plate.

The beneficial effects of the present invention are that, at one side of the flat panel luminaire, a primary light projection region with high illuminance can be formed and at the other side of the flat panel luminaire, a secondary light projection region with low illuminance can be formed, so that illumination brightness in a region outside an illumination range of the primary light projection region can be balanced with light of the secondary light projection region, avoiding the visual discomfort problem caused by inadequate illumination brightness and strong brightness contrast in a region outside a light projection region due to a single light projection region.

In order to further understand the features and technical content of the present invention, reference is made to the following detailed description and accompanying drawings of the present invention. However, the accompanying drawings are only intended for reference and illustration, but do not limit the present invention.

### BRIEF DESCRIPTION OF THE DRAWINGS

FIG. 1 is a perspective exploded view of a flat panel luminaire of the present invention;

FIG. 2 is a perspective view of an partial assembly of the flat panel luminaire of the present invention;

FIG. 3 is a sectional front view of an assembly of the flat panel luminaire of the present invention;

FIG. 3A is a schematic sectional view showing a first arrangement of a semi-transmitting layer in the flat panel luminaire of the present invention;

FIG. 3B is a schematic sectional view showing a second arrangement of a semi-transmitting layer in the flat panel luminaire of the present invention;

FIG. 4 is an assembled perspective view of a flat panel luminaire of the present invention according to a first application embodiment;

FIG. 5 is an assembled perspective view of a flat panel luminaire of the present invention according to a second application embodiment; and

FIG. 6 is an assembled perspective view of a flat panel luminaire of the present invention according to a third application embodiment.

### DETAILED DESCRIPTION OF THE PREFERRED EMBODIMENTS

### First Embodiment

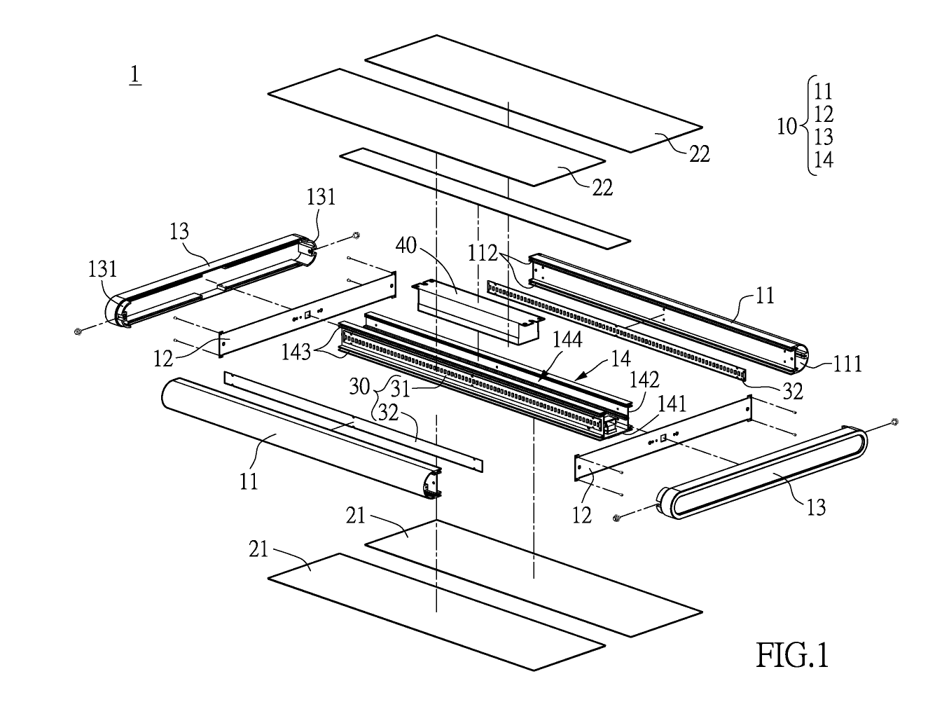

Referring to FIG. 1 to FIG. 4, a flat panel luminaire 1 is provided. The flat panel luminaire 1 is characterized by having two light outgoing directions and being capable of diffusing and projecting light towards two sides of the flat panel luminaire 1 in different proportions respectively, so as to achieve the effect of balancing illuminance outside a primary light projection region of the luminaire and thus avoiding too strong visual contrast.

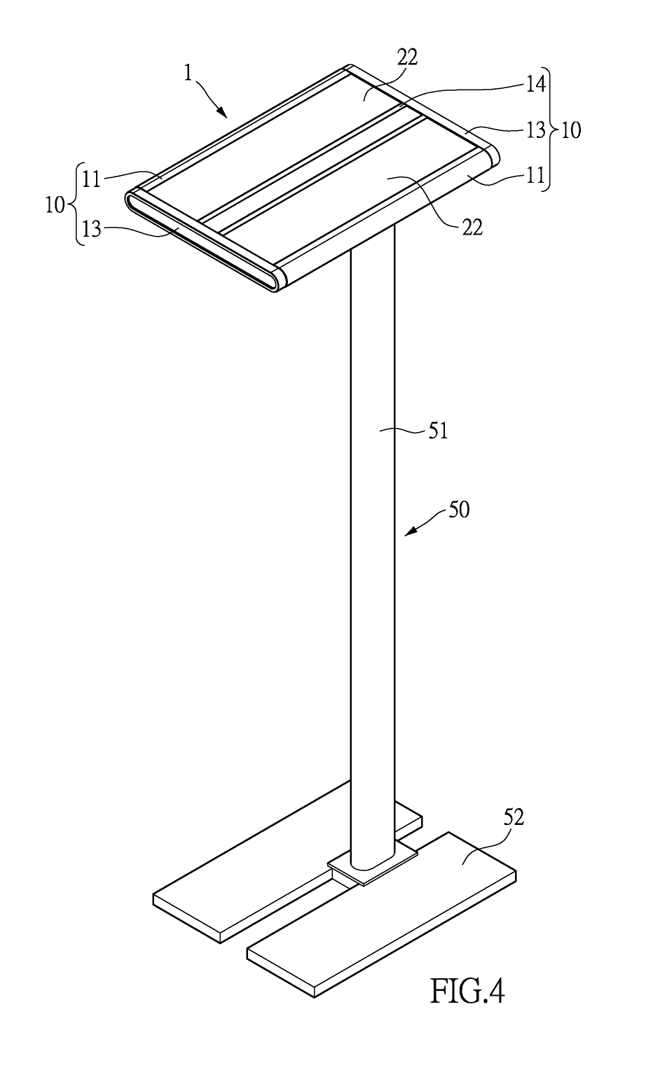

As shown in FIG. 1 to FIG. 3, the main structure of the flat panel luminaire 1 of the present invention comprises: a frame assembly 10, a first light transmitting plate 21, a second light transmitting plate 22, and at least one light emitting device 30. As shown in FIG. 4, in the first embodiment of the present invention, the flat panel luminaire 1 is combined with a foot stand 50 to form an indoor illumination lamp, which may be placed on an indoor floor. The foot stand includes a pedestal 52 configured to be placed on a floor and an upright rod 51 vertically disposed on the pedestal 52. The frame assembly 10 of the flat panel luminaire 1 is connected to a top end of the upright rod 51, and thus the foot stand 50 can support the flat panel luminaire 1 in a position above the ground.

In the structure of the flat panel luminaire 1 of the present invention, the frame assembly 10 has a rectangular frame. The frame assembly 10 is formed of a plurality of frames and connection plates (described later). An accommodating space 15 is formed at an inner side of the frame assembly 10. The first light transmitting plate 21 and the second light transmitting plate 22 are disposed at two sides of the accommodating space 15. The light emitting device 30 includes a plurality of first light emitting strips 31 and a plurality of second light emitting strips 32. The first light emitting strips 31 and the second light emitting strips 32 are disposed in the accommodating space 15 of the frame assembly 10 and located between the first light transmitting plate 21 and the second light transmitting plate 22. After being reflected and diffused by the first light transmitting plate 21 and the second light transmitting plate 22, light generated by the light emitting device 30 is transmitted through the first light transmitting plate 21 and the second light transmitting plate 22 respectively, so that illumination light is projected from two sides of the flat panel luminaire of the present invention. The direction of light generated by the light emitting device 30 and transmitted from the first light transmitting plate 21 is defined as a first light outgoing direction A, and the direction of light generated by the light emitting device 30 and transmitted from the second light transmitting plate 22 is defined as a second light outgoing direction B.

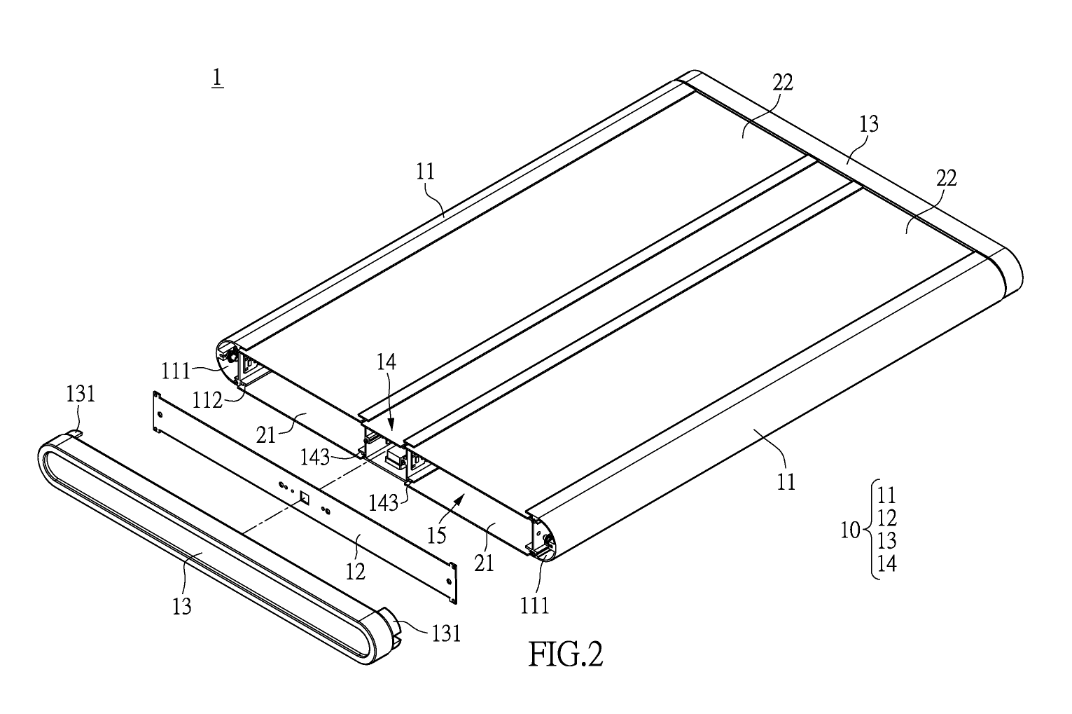

The first light transmitting plate 21 and the second light transmitting plate 22 of the present invention are characterized in that, the first light transmitting plate 21 and the second light transmitting plate 22 are semi-reflecting light-transmitting plates having a light diffusion function and the first light transmitting plate 21 and the second light transmitting plate 22 have different light transmittances, so that light transmitted by the flat panel luminaire 1 of the present invention has different illumination intensities in the first light outgoing direction A and the second light outgoing direction B. In the embodiment shown in FIG. 1 and FIG. 2, each of the first light transmitting plate 21 and the second light transmitting plate 22 is formed by combining two smaller plates. However, in actual practice, the number and configuration of the first light transmitting plate 21 or the second light transmitting plate 22 are not limited to those shown in the figures.

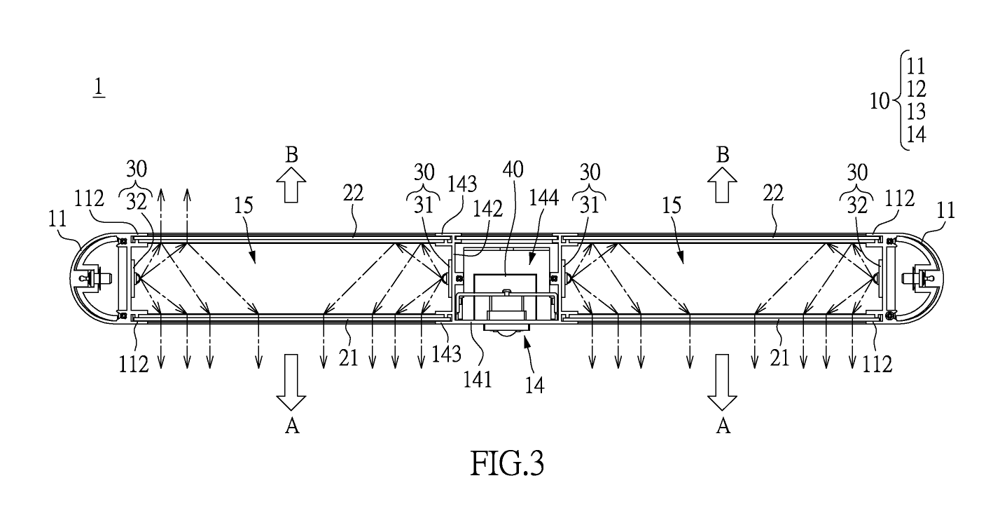

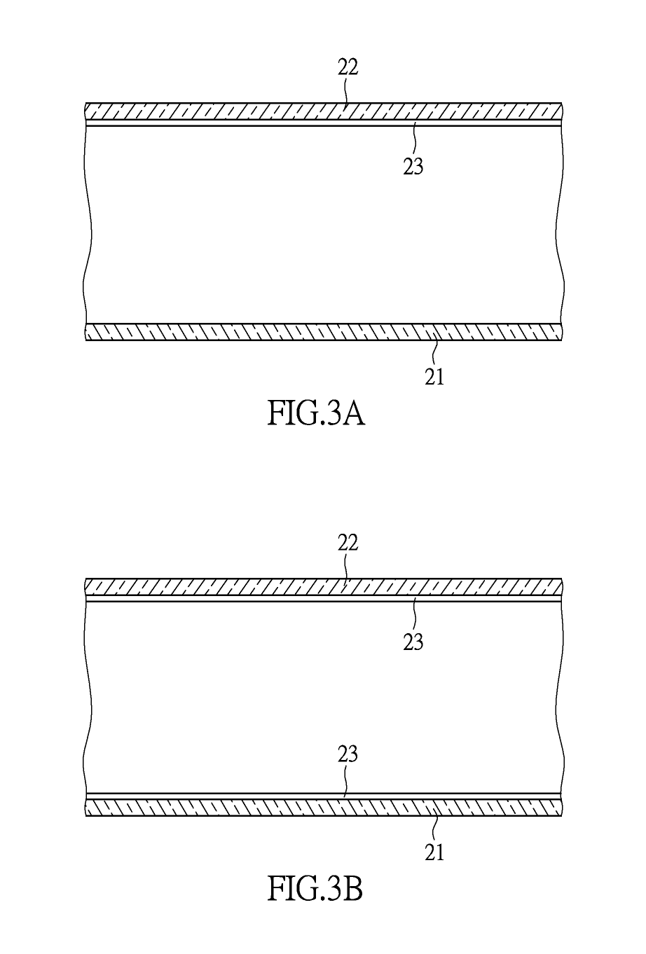

In order to achieve the above-mentioned function, the following specific technical means are used for the first light transmitting plate 21 and the second light transmitting plate 22 of the present invention. First, a light transmitting material having a light diffusion function, for example, a fog-like acrylic plate or frosted glass plate, may be selected for the first light transmitting plate 21 and the second light transmitting plate 22. Furthermore, a semi-reflecting material may be disposed on opposite inner sides of the first light transmitting plate 21 and the second light transmitting plate 22 by means of polishing, evaporation, coating, or attaching, so that opposite inner sides of the first light transmitting plate 21 and the second light transmitting plate 22 have partial light reflection capability, and thus when light of the light emitting device 30 is projected onto the inner surfaces of the first light transmitting plate 21 and the second light transmitting plate 22, a part of the light is transmitted through the first light transmitting plate 21 and the second light transmitting plate 22 and a part of the light is reflected by the inner surfaces of the first light transmitting plate 21 and the second light transmitting plate 22. Therefore, as shown in FIG. 3, the light emitted by the light emitting device 30 is delivered along paths of repeated reflections between the first light transmitting plate 21 and the second light transmitting plate 22, so that the light is evenly distributed on the surfaces of the first light transmitting plate 21 and the second light transmitting plate 22 and transmitted out of the first light transmitting plate 21 and the second light transmitting plate 22, and thus the light generated by the light emitting device 30 is changed from the original point-light-source form to a face-light-source form.

Different light transmittances of the first light transmitting plate 21 and the second light transmitting plate 22 of the present invention can be achieved by the following method. Firstly, materials with different light transmission coefficients may be selected for the first light transmitting plate 21 and the second light transmitting plate 22. Secondly, dyes or dopants affecting light transmittance may be added so that the first light transmitting plate 21 and the second light transmitting plate 22 have different light transmittances. Thirdly, as shown in FIG. 3A, a semi-transmitting layer 23 is disposed on the surface of one of the first light transmitting plate 21 and the second light transmitting plate 22 so that the light transmittance of the one of the first light transmitting plate 21 and the second light transmitting plate 22 provided with the semi-transmitting layer 23 is lower than the light transmittance of the other light transmitting plate. Alternatively, as shown in FIG. 3B, the semi-transmitting layer 23 is disposed on the surface of each of the first light transmitting plate 21 and the second light transmitting plate 22, and the semi-transmitting layer 23 disposed on the surface of the first light transmitting plate 21 has a light transmittance different from that of the second light transmitting plate 22 so that the first light transmitting plate 21 and the second light transmitting plate 22 have different light transmittances. The semi-transmitting layer 23 may be disposed on the surface of the first light transmitting plate 21 or the second light transmitting plate 22 through different technical means, which are preferably, but not limited to, evaporation, coating, printing or attaching. The semi-transmitting layer 23 may be a semi-reflecting film or coating.

Through the foregoing technical means, the first light transmitting plate 21 and the second light transmitting plate 22 are formed as semi-transmitting plates with different light transmittances, and thus light projected from the flat panel luminaire 1 in the first light outgoing direction A and the second light outgoing direction B has different illumination intensities. For the embodiment shown in FIG. 3 and FIG. 4, the semi-transmitting layer 23 is disposed on the surface of the second light transmitting plate 22 so that the light transmittance of the second light transmitting plate 22 is lower than that of the first light transmitting plate 21, and thus an amount of light projected from the side of the first light transmitting plate 21 of the flat panel luminaire 1 is greater than that projected from the side of the second light transmitting plate 22. Therefore, the illumination intensity is higher in the first light outgoing direction A of the flat panel luminaire 1, forming a primary light projection region, and the illumination intensity is lower in the second light outgoing direction B, forming a secondary light projection region.

Thus, as shown in FIG. 4, the flat panel luminaire 1 is horizontally disposed on the top end of the foot stand 50. The first light transmitting plate 21 of the flat panel luminaire 1 faces the ground and a side of the second light transmitting plate 22 is arranged facing the ceiling. Therefore, the primary light projection region of the flat panel luminaire 1 faces the ground, achieving the purpose of illuminating an indoor ground in the region below the flat panel luminaire 1, and the secondary light projection region faces the ceiling, so that a part of the light of the flat panel luminaire 1 is projected onto the ceiling or wall in the position over the flat panel luminaire 1, and thus the ceiling or wall in the position over the flat panel luminaire 1 is not completely dark. Thus, the brightness and light-shade contrast in the regions in an indoor space are not too strong, avoiding the visual discomfort problem caused by uneven illuminance in the regions above and below the flat panel luminaire 1.

The frame assembly 10 of the flat panel luminaire 1 of the present invention has: two side frames 11, two connection plates 12, a central support 14, and two end covers 13. The two side frames 11 are disposed in parallel to each other at two sides of the frame assembly 10. The two side frames 11 are long rods made by aluminum extrusion, where each of two ends of the side frames 11 has a connection end 111. The sectional shape of the two side frames 11 is as follows: outer sides are arc-shaped and opposite inner sides of the two side frames 11 are planar.

The two connection plates 12 are metal plates. The two connection plates 12 are perpendicular to the two side frames 11 and are connected to the connection ends 111 at two ends of the two side frames 11 through screw fastening. The two connection plates 12 and the two side frames 11 jointly form a body structure of the frame assembly 10 and an accommodating space 15 is enclosed at inner sides of the two side frames 11 and the connection plates 12.

The central support 14 is further disposed between the two side frames 11, as shown in FIG. 1 and FIG. 3. The central support 14 may also be made by aluminum extrusion. In this embodiment, the central support 14 has a bottom plate 141 and two side plates 142 integrally formed and connected to a top surface of the bottom plate 141 at two sides. An accommodating groove 144 is formed between the two side plates 142 for accommodating a control circuit 40 of the flat panel luminaire 1. Two ends of the central support 14 are connected to inner sides of the two connection plates 12, so that two side frames 11, two connection plates 12, and the central support 14 jointly form a stable frame.

In this embodiment of the present invention, each of the two side frames 11 are provided with two first engaging grooves 112 at an upper edge and a lower edge of the inner side thereof, and each of the two side plates 142 of the central support 14 are provided with a plurality of second engaging grooves 143 corresponding in position to the first engaging grooves 112 at an upper edge and a lower edge thereof. Two side edges of the first light transmitting plate 21 and two side edges of the second light transmitting plate 22 are respectively engaged between the first engaging grooves 112 and the second engaging grooves 143, so that the first light transmitting plate 21 and the second light transmitting plate 22 are engaged with the two side frames 11 and the central support 14.

The two end covers 13 of the frame assembly 10 are perpendicular to the two side frames 11 and are located outside the two connection plates 12. Each of the two end covers 13 is provided with two flange portions 131 at two ends thereof, which are engaged with the connection ends 111 of the two side frames 11. The two flange portions 131 can be inserted into the connection ends 111 at the two ends of the two side frames 11 so that the two ends of the two end covers 13 are combined with the connection ends 111 of the two side frames 11. The function of the two end covers 13 is, on one hand, to make the flat panel luminaire 1 at the two ends of the two side frames 11 in a closed state, and on the other hand, to form a part of the structure of the frame assembly 10 to increase the overall strength.

The light emitting device 30 of the flat panel luminaire 1 includes two first light emitting strips 31 and two second light emitting strips 32. The two first light emitting strips 31 are disposed on surfaces of the two side plates of the central support 14. The second light emitting strips 32 are disposed on opposite inner sides of the two side frames 11. In this embodiment, each of the first light emitting strips 31 and the second light emitting strips 32 of the light emitting device 30 is formed of an elongated circuit substrate and a plurality of light emitting diodes disposed on the circuit substrate. Of course, another type of light emitting element, for example, a fluorescent tube or a cold-cathode tube may also be used for the light emitting device 30.

The flat panel luminaire 1 in the first embodiment of the present invention is an indoor illumination lamp placed on the ground. However, the flat panel luminaire 1 of the present invention may also be used in other applications, which are further described below.

### Second Embodiment

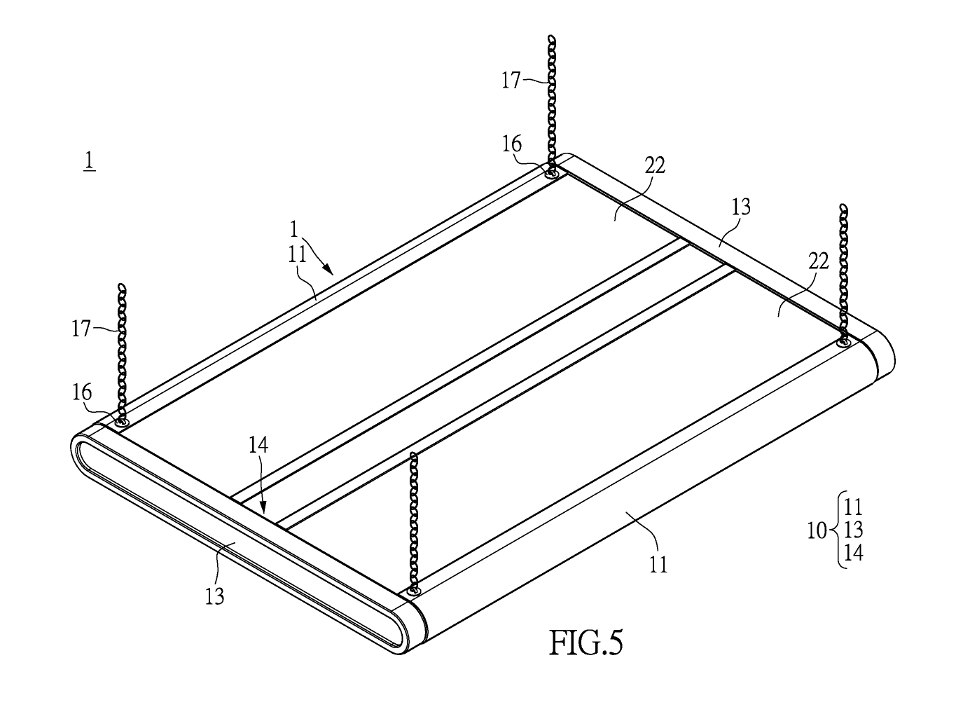

As shown in FIG. 5, a second embodiment of the present invention is shown. In this embodiment, the flat panel luminaire 1 is a pendant lamp, where a plurality of suspending members 17 is provided at a top surface of the frame assembly 10 and each connection member 16 is connected to one of the suspending members 17. The flat panel luminaire is suspended below an indoor ceiling or another structure through the connection members 16 and the suspending members 17 so that the flat panel luminaire 1 becomes a suspending luminaire.

### Third Embodiment

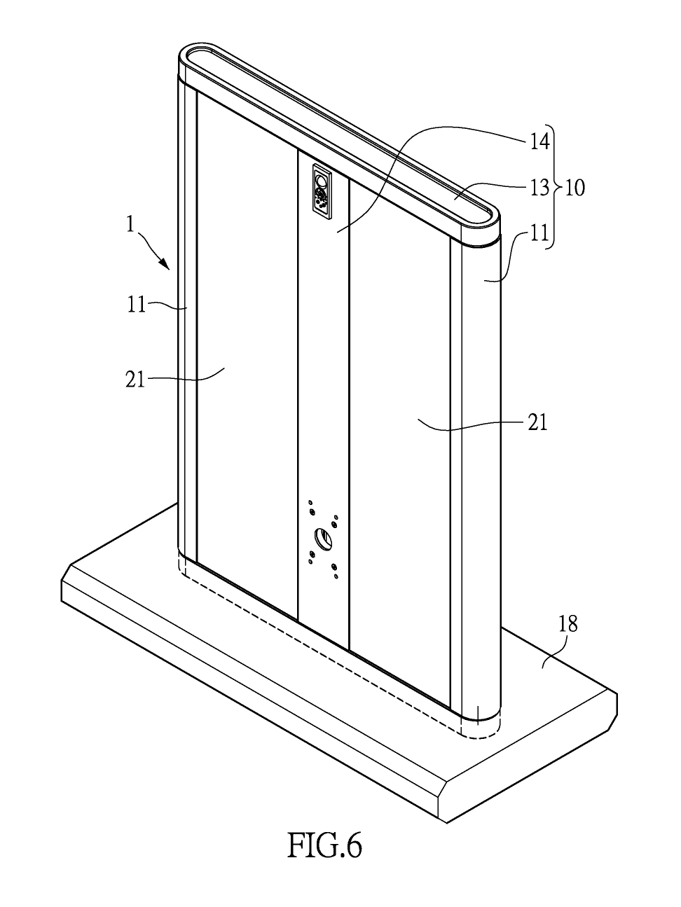

FIG. 6 shows a flat panel luminaire 1 according to another application embodiment of the present invention. In this embodiment, an end of the flat panel luminaire 1 is connected to a base 18 so that the flat panel luminaire 1 is perpendicularly disposed on a top surface of the base 18. Therefore, the flat panel luminaire 1 becomes a vertical luminaire capable of being placed on the ground. The flat panel luminaire 1 in this embodiment may also be used as a movable billboard luminaire or a mobile illumination lamp.

### Possible Effects of the Embodiments

To sum up, the beneficial effects of the present invention are that, at one side of the flat panel luminaire 1, a primary light projection region with high illuminance can be formed and at the other side of the flat panel luminaire 1, a secondary light projection region with low illuminance can be formed. Therefore, illumination brightness in a region outside an illumination range of the primary light projection region can be balanced with light of the secondary light projection region, avoiding the visual discomfort problem caused by inadequate illumination brightness and strong brightness contrast in a region outside a light projection region due to a single light projection region.

The description above is only preferred embodiments of the present invention, and is not intended to limit the scope of the present invention. All equivalent technical changes made according to the specification and drawings of the present invention should fall within the scope of the present invention.

What is claimed is:

1. A flat panel luminaire, comprising:
a frame assembly, enclosing an accommodating space;
a first light transmitting plate, disposed at one side of the accommodating space of the frame assembly;
a second light transmitting plate, disposed at the other side of the accommodating space of the frame assembly in parallel to and opposite to the first light transmitting plate; and
at least one light emitting device, disposed in the accommodating space and located between the first light transmitting plate and the second light transmitting plate, wherein light emitted by the light emitting device passes through the first light transmitting plate and the second light transmitting plate respectively, wherein
the first light transmitting plate and the second light transmitting plate have different light transmittances, so that an illumination intensity of light generated by the light emitting device and transmitted from the direction of the first light transmitting plate is different from an illumination intensity of light generated by the light emitting device and transmitted from the direction of the second light transmitting plate.

2. The flat panel luminaire according to claim 1, wherein a first semi-transmitting layer is provided at an inner side of the first light transmitting plate or the second light transmitting plate, so that a light transmittance of one of the first light transmitting plate and the second light transmitting plate that is provided with the first semi-transmitting layer is lower than a light transmittance of the other of the first light transmitting plate and the second light transmitting plate that is not provided with the first semi-transmitting layer.

3. The flat panel luminaire according to claim 2, wherein the other of the first light transmitting plate and the second light transmitting plate that is not provided with the first semi-transmitting layer is provided with a second semi-transmitting layer, wherein a light transmittance of the second semi-transmitting layer is higher than a light transmittance of the first semi-transmitting layer.

4. The flat panel luminaire according to claim 3, wherein the frame assembly includes:
two side frames parallel to each other, wherein each of two ends of the two side frames has a connection end;
two connection plates, disposed at two ends of the two side frames in perpendicular to the two side frames, wherein two ends of the two connection plates are connected to the connection ends of the two side frames, respectively and the two connection plates and the two side frames together enclose the accommodating space;
a central support, disposed between the two side frames in parallel to the two side frames, wherein two ends of the central support are connected to inner sides of the two connection plates respectively; and
two end covers, disposed outside the two connection plates in perpendicular to the two side frames, wherein two ends of the two end covers are connected to the connection ends of the two side frames respectively.

5. The flat panel luminaire according to claim 4, wherein a first engaging groove is provided at each of an upper edge and a lower edge of an inner side of each of the two side frames, sides of the first light transmitting plate and the second light transmitting plate adjacent to the side frames being engaged in the two first engaging grooves; and a plurality of second engaging grooves is provided at an upper edge and a lower edge of each of two sides of the central frame, sides of the first light transmitting plate and the second light transmitting plate adjacent to the central frame being engaged in the plurality of second engaging grooves.

6. The flat panel luminaire according to claim 5, wherein the light emitting device includes: two first light emitting strips, respectively disposed on sides of the central support facing the two side frames; and two second light emitting strips, respectively disposed on sides of the two side frames facing the central support.

7. The flat panel luminaire according to claim 6, wherein each of the first light emitting strips and the second light emitting strips has a substrate and a plurality of light emitting diodes disposed on the substrate.

8. The flat panel luminaire according to claim 1, further comprising a foot stand having a pedestal and an upright rod vertically disposed on the pedestal, wherein the frame assembly is connected to a top end of the upright rod.

9. The flat panel luminaire according to claim 1, wherein a plurality of connection members is provided at a top surface of the frame, each of the plurality of connection members is connected to a suspending member, and the frame assembly is suspended from a bottom surface of an indoor ceiling through the suspending members.

10. The flat panel luminaire according to claim 1, further comprising a base, wherein an end of the frame assembly is disposed on a top surface of the base.
